(19) United States
(12) Patent Application Publication
(10) Pub. No.: US 2021/0198396 A1
(43) Pub. Date: Jul. 1, 2021

(54) BISMALEIMIDE CROSS-LINKER FOR LOW LOSS DIELECTRIC

(71) Applicant: Rohm and Haas Electronic Materials LLC, Marlborough, MA (US)

(72) Inventors: Jaclyn Murphy, Ashland, MA (US); Colin Hayes, Hudson, MA (US); Michael K. Gallagher, Hopkinton, MA (US); Kristen Flajslik, Hopskinton, MA (US); Charles R. Kinzie, Boston, MA (US); Colin Calabrese, Marlborough, MA (US); Qing Min Wang, North Andover, MA (US)

(21) Appl. No.: 17/113,147

(22) Filed: Dec. 7, 2020

Related U.S. Application Data
(60) Provisional application No. 62/954,737, filed on Dec. 30, 2019.

(51) Int. Cl. C08F 212/32; C08F 2/06; C08F 236/04; C08K 5/3415; B05D 7/24

(52) U.S. Cl. CPC C08F 212/32; C08F 2/06; C08F 236/04; B05D 2518/00; B05D 7/24; C08F 2810/20; C08K 5/3415

(57) ABSTRACT

The present disclosure relates to a chemical composition produced from polymerizing an arylcyclobutene monomer, and a bismaleimide compound as a cross-linker; and its use, especially in electronic devices.

### FIELD OF THE DISCLOSURE

The present disclosure relates to a chemical composition comprising a polymer produced from polymerizing an arylcyclobutene monomer, and a bismaleimide compound as a cross-linker; and its use, especially in electronic devices.

### BACKGROUND INFORMATION

Polymeric resins are used in spin-on dielectric packaging, circuit boards, laminates, and other electronic applications. The resins need to provide films/coatings having good mechanical properties and good adhesive properties, as well as low dielectric properties. In particular, it is desirable to have high tensile strength, high tensile elongation, good adhesion to copper, and low relative permittivity (Dk) and loss tangent (Df) at high frequencies. In addition, it is desirable to be able to cure the resins at lower temperatures without excessive cure times.

There is a continuing need for dielectric resin compositions which have improved properties.

### DETAILED DESCRIPTION

Many aspects and embodiments have been described above and are merely exemplary and not limiting. After reading this specification, skilled artisans appreciate that other aspects and embodiments are possible without departing from the scope of the present disclosure.

As used throughout this specification, the following abbreviations shall have the following meanings, unless the context clearly indicates otherwise: ° C.=degree Celsius; g=gram; nm=nanometer, μm=micron=micrometer; mm=millimeter; MPa=mega Pascals; sec.=second; and min.=minutes. All amounts are percent by weight (“wt. %”) and all ratios are molar ratios, unless otherwise noted. All numerical ranges are inclusive and combinable in any order, except where it is clear that such numerical ranges are constrained to added up to 100%. Unless otherwise noted, all polymer and oligomer molecular weights are weight average molecular weights (‘Mw”) with unit of g/mol or Dalton, and are determined using gel permeation chromatography compared to polystyrene standards.

The articles “a”, “an” and “the” refer to the singular and the plural, unless the context clearly indicates otherwise. As used herein, the term “and/or” includes any and all combinations of one or more of the associated items. The term “curable” refers to a material that becomes harder and less soluble in solvents under the conditions of use.

The terms “film” and “layer” are used interchangeably through this specification. The term “monomer” refers to a molecule that can undergo polymerization or copolymerization thereby contributing constitutional units to the essential structure of a macromolecule (a polymer). The term “polymer” refers to molecules composed of repeating monomer units. The term “polymer” used herein refers to a homopolymer composed of one monomer unit, and/or a copolymer composed of two or more different monomers as polymerized units. Polymers in the present disclosure may contain organic and/or inorganic additives.

The term “adjacent” as it refers to substituent groups that are bonded to carbons that are joined together with a single or multiple bond. Exemplary adjacent R groups are shown below:

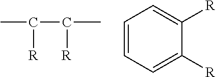

The term “alkoxy” refers to a group RO—, where R is an alkyl group. The term “alkyl” refers to a group derived from an aliphatic hydrocarbon and includes a linear, a branched, or a cyclic group. A group “derived from” a compound, indicates the radical formed by removal of one or more hydrogen or deuterium. In some embodiments, an alkyl has from 1-20 carbon atoms.

The term “aromatic compound” refers to an organic compound comprising at least one unsaturated cyclic group having 4n+2 delocalized pi electrons. The term “aryl” refers to a group derived from an aromatic compound having one or more points of attachment. The term includes groups which have a single ring and those which have multiple rings which can be joined by a single bond or fused together. Carbocyclic aryl groups have only carbons in the ring structures. Heteroaryl groups have at least one heteroatom in a ring structure. The term “alkylaryl” refers to an aryl group having one or more alkyl substituents. The term “aryloxy” is refers to a group RO—, where R is an aryl group.

The term “liquid composition” refers to a liquid medium in which a material is dissolved to form a solution, a liquid medium in which a material is dispersed to form a dispersion, or a liquid medium in which a material is suspended to form a suspension or an emulsion. The term “solvent” refers to an organic compound that is a liquid at room temperature (20-25° C.). The term is intended to encompass a single organic compound or mixture of two or more organic compounds.

Unless otherwise defined, all technical and scientific terms used herein have the same meaning as commonly understood by one of ordinary skill in the art to which this disclosure belongs. Although methods and materials similar or equivalent to those described herein can be used in the practice or testing of embodiments of the present disclosure, suitable methods and materials are described below. In addition, the materials, methods, and examples are illustrative only and not intended to be limiting.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the disclosed subject matter hereof, is described as consisting essentially of certain features or elements, in which embodiment features or elements that would materially alter the principle of operation or the distinguishing characteristics of the embodiment are not present therein. A further alternative embodiment of the described subject matter hereof is described as consisting of certain features or elements, in which embodiment, or in insubstantial variations thereof, only the features or elements specifically stated or described are present.

To the extent not described herein, many details regarding specific materials, processing acts, and circuits are conventional and may be found in textbooks and other sources within the photoresist, organic light-emitting diode display, photodetector, photovoltaic cell, and semiconductive member arts.

There is provided a chemical composition comprising a polymer produced from polymerizing an arylcyclobutene monomer, and a bismaleimide compound.

The chemical composition can contain 5 to 50 wt. %, or 5 to 40 wt. %, or 10 to 30 wt. %, or 15 to 25 wt. % of the bismaleimide compound based on the total amounts of the composition. The bismaleimide compound can be represented by a general formula (I) as shown below:

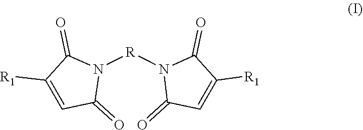

where R is substituted or unsubstituted linking group selected from the group consisting of alkylene, alkylenearyl, cycloalkylene, cycloalkylenearyl, cycloalkylalkylene, dialkyl siloxane, diarylsiloxane, aryl, heteroaryl, aryloxy, arylamino, arylthio, and combinations thereof; and R₁ is selected from the group consisting of hydrogen, deuterium, halogen, cyano, methyl, vinyl, allyl, isoprene, a substituted or unsubstituted isoprene having 1-100 carbon atoms, alkyne, substituted alkyne, and combinations thereof. In some embodiments, R can be alkylene group having 1 to 100 carbon atoms, or 10 to 100 carbon atoms, or 2 to 50 carbon atoms, or 5 to 20 carbon atoms.

In one embodiment, R is substituted or unsubstituted linking group selected from the group consisting of alkylene having 10 to 100 carbon atoms, alkylenearyl, cycloalkylene, cycloalkylenearyl, cycloalkylalkylene, and combinations thereof.

Examples of the bismaleimide compound can include, but are not limited to, C36 alkylenediamine imides such as 1,1′-((4-hexyl-3-octylcyclohexane-1,2-diyl)bis(octane-8,1-diyl))bis(1H-pyrrole-2,5-dione) (BMI-689, commercially available from Designer Molecules), 1,6′-bismaleimide-(2,2,4-trimethyl)hexane (TMH-BMI, commercially available from Daiwa Kasei Industry Co., Ltd., Japan), 1,3-bis(3-maleimidephenoxy)benzene (APB-BMI, commercially available from Hampford Research, Inc.), 1,1′-[2,2′-Bis(trifluoromethyl)[1,1′-biphenyl]-4,4′-diyl]bis[1H-pyrrole-2,5-dione] (MA-TFMB), 2,2-Bis[4-(4-maleimidophenoxy)phenyl]hexafluoropropane (BMP3 CF3), and 1,3-Bis(4-maleimidophenoxy)benzene (1,3 Bis 4-PhoBMI), 1-(3-(5-(2,5-dioxo-2,5-dihydro-1H-pyrrol-1-yl)benzo[d]oxazol-2-yl)phenyl)-1H-pyrrole-2,5-dione, 1,1′-(sulfonylbis(4,1-phenylene))bis(1H-pyrrole-2,5-dione), 1,1′-(sulfonylbis(3,1-phenylene))bis(1H-pyrrole-2,5-dione), 1,1′-((1,1,3,3-tetramethyldisiloxane-1,3-diyl)bis(propane-3,1-diyl))bis(1H-pyrrole-2,5-dione), 1,1′-(methylenebis(2-ethyl-6-methyl-4,1-phenylene))bis(1H-pyrrole-2,5-dione) (BMI5100, commercially available as from Daiwa Kasei Industry Co., Ltd., Japan), 1,1′-(1,3-phenylene)bis(1H-pyrrole-2,5-dione) (BMI3000H, commercially available as from Daiwa Kasei Industry Co., Ltd., Japan), 1,1′-(decane-1,10-diyl)bis(1H-pyrrole-2,5-dione), 1,1′-(1,3,5-triazine-2,4-diyl)bis(1H-pyrrole-2,5-dione), 1,1′-((perfluoropropane-2,2-diyl)bis(4,1-phenylene))bis(1H-pyrrole-2,5-dione), 1,1′-((9H-fluorene-9,9-diyl)bis(4,1-phenylene))bis(1H-pyrrole-2,5-dione), and 1,1′-(methylenebis(4,1-phenylene))bis(1H-pyrrole-2,5-dione).

The arylcyclobutene monomer has a general formula (II) or (III), as shown below:

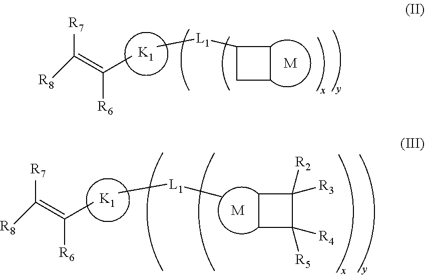

where:
K₁ is a divalent group selected from the group consisting of alkyl, aryl, carbocyclic aryl, polycyclic aryl, heteroaryl, aryloxy, arylalkyl, carbonyl, ester, carboxyl, ether, thioester, thioether, tertiary amine, and combinations thereof;
L₁ is a covalent bond or a multivalent linking group;
M is a substituted or unsubstituted divalent aromatic or polyaromatic radical group, or a substituted or unsubstituted divalent heteroaromatic radical group;
R₂-R₅ are identical or different and each is independently selected from the group consisting of unsubstituted or substituted alkyl, unsubstituted or substituted alkyloxy, unsubstituted or substituted aryl, unsubstituted or substituted aryloxy, alkylthio, arylthiol, substituted alkyl amino, substituted aryl amino, and combinations thereof;
R₆-R₈ are identical or different and each is independently selected from the group consisting of hydrogen, deuterium, cyano, halo or methyl, vinyl, allyl, isoprene, and a substituted or unsubstituted isoprene having 1-100 carbon atoms, and combinations thereof; and x and y are the same or different and are an integer from 1-5, wherein when L₁ is a covalent bond, y=1.

Examples of the arylcyclobutene monomer can include, but are not limited to, 1-(4-vinyl phenoxy)-benzocyclobutene, 1-(4-vinyl methoxy)-benzocyclobutene, 1-(4-vinyl phenyl)-benzocyclobutene, 1-(4-vinyl hydroxynaphthyl)-benzocyclobutene, 4-vinyl-1-methyl-benzocyclobutene, 4-vinyl-1-methoxy-benzocyclobutene, and 4-vinyl-1-phenoxy-benzocyclobutene.

There is also provided a chemical composition comprising a polymer produced from copolymerizing an arylcyclobutene monomer and a monomer comprising one or more dienophile moieties, and a bismaleimide compound.

The arylcyclobutene monomers and the bismaleimide compound are the same as described above. The monomer comprising one or more dienophile moieties can be represented in general formula (IV) as shown below:

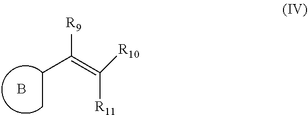

where:
B is hydrogen, substituted or unsubstituted alkyl, substituted or unsubstituted aromatic moiety, substituted or unsubstituted heteroaromatic moiety, hydroxy, or substituted or unsubstituted alkyloxy; and
R₉-R₁₁ are identical or different and each independently is selected from the group consisting of hydrogen, methyl, vinyl, allyl, isoprene, a substituted or unsubstituted isoprene having 1-100 carbon atoms, a substituted or unsubstituted alkyl group having 1 to 100 carbon atoms, a halogen, a cyano, a substituted or unsubstituted aryl group having 6 to 100 carbon atoms, a substituted or unsubstituted heteroaryl group having 6 to 100 carbon atoms, and combinations thereof.

In one embodiment, the dienophile monomer can be an aromatic vinyl monomer, which is has Formula (V):

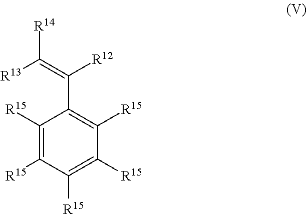

where:
R¹²-R¹⁴ are the same or different at each occurrence and is selected from the group consisting of hydrogen and C₁₋₅ alkyl; and
R¹⁵ is the same or different at each occurrence and is selected from the group consisting of hydrogen and C₁₋₅ alkyl, where adjacent R¹⁵ groups can be joined to form a fused 6-membered aromatic ring.

Examples of the aromatic vinyl monomer can include, but are not limited to, styrene, α-methylstyrene, vinyl toluene, 1-vinylnaphthalene, and 2-vinylnaphthalene.

In one aspect, a chemical composition of the present disclosure can comprise a polymer produced from copolymerizing an arylcyclobutene monomer, a monomer comprising one or more dienophile moieties, and at least one diene monomers; and a bismaleimide compound. The arylcyclobutene monomer, the monomer comprising one or more dienophile moieties, and the bismaleimide compound are the same as those described above.

The diene monomer can have a general formula (VI), as shown below:

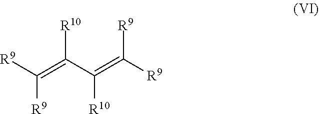

where R⁹ is the same or different at each occurrence and is selected from the group consisting of hydrogen and methyl; and
R^{m} is the same or different at each occurrence and is selected from the group consisting of hydrogen, C₁₋₅ alkyl, C₁₋₅ alkoxy, C₁₋₅ thioalkyl, and C₅₋₁₂ alkenyl.
Examples of the diene monomers can include, but are not limited to, butadiene, isoprene, 1,3-pentadiene, 2,4-hexadiene, cyclopentadiene, β-myrcene, ocimene, cyclooctadiene, farnesene, and polymerizable terpenes.

In another aspect, a chemical composition of the present disclosure can comprise a polymer produced from copolymerizing an arylcyclobutene monomer, a monomer comprising one or more dienophile moieties, at least one diene monomers and at least one heterocycle containing monomer; and a bismaleimide compound. The arylcyclobutene monomer, the monomer comprising one or more dienophile moieties, the diene monomer, and the bismaleimide compound are the same as those described above.

The heterocycle containing monomer can be a vinyl substituted C₃₋₁₂ heterocycle, or a vinyl-substituted C₃₋₅ heterocycle. In one embodiment, the heterocycle can be further substituted with one or more C₁₋₆ alkyl, a C₆₋₁₂ carbocyclic aryl, or a C₃₋₁₂ heteroaryl.

The heterocycle containing monomer is selected from the group consisting of nitrogen heterocycles, sulfur heterocycles, nitrogen-sulfur heterocycles, and substituted derivatives thereof.

In one embodiment, the heterocycle containing monomer can be a nitrogen heterocycle containing monomer. The nitrogen heterocycle containing monomer can comprise at least one ring nitrogen. Examples of the nitrogen heterocycle containing monomer can include, but are not limited to, pyrrole, pyridine, diazines, triazines, imidazoles, benzoimidazoles, and quinolones.

The nitrogen heterocycle containing monomer can have a general formula (VII), as shown below:

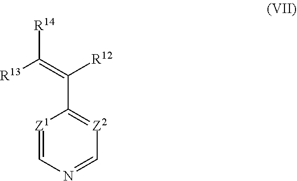

where Z¹ and Z² are the same or different and are N or CR^{15a};
R¹²-R¹⁴ and R^{15a} are the same or different at each occurrence and are selected from the group consisting of hydrogen and C₁₋₅ alkyl.

Examples of such nitrogen heterocycle containing monomer can include, but are not limited to, 4-vinyl pyridine, 4-vinyl-1,3-diazine, 2-vinyl-1,3,5-triazine, and 4-methyl-5-vinyl-1,3-thiazole.

In another embodiment, the heterocycle containing monomer can be a sulfur heterocycle containing monomer. The sulfur heterocycle containing monomer can comprise at least one ring sulfur. Examples of sulfur heterocycle containing monomers can include, but are not limited to, thiophene, benzothiophene, and dibenzothiophene.

In yet another embodiment, the heterocycle containing monomer can be a nitrogen-sulfur heterocycle containing monomer. The nitrogen-sulfur heterocycle containing monomer can comprise at least one ring nitrogen and one ring sulfur. Examples of the nitrogen-sulfur heterocycle containing monomers can include, but are not limited to thiazole, thiadiazole, and thiadiazine.

A polymer can be formed by polymerizing or copolymerizing the above-described monomer(s) by the action of a thermal initiator, a photoinitiator or other photoactive compounds. In one embodiment, a polymer can be formed by mixing the monomer(s) of the chemical composition and a radical initiator in a polar solvent, heating to a temperature of 50 to 100° C., or 50 to 90° C. over a period of 5-50 hours. In another embodiment, a polymer can be formed by mixing the monomer(s) of the chemical composition in a polar solvent, heating to a temperature of 50-100° C., or 50 to 90° C. to form a heated mixture, and continuously feeding a radical initiator into the heated mixture over a period of 5-50 hours. After the desired reaction time, the resulting final reaction mixture is obtained, cooled to room temperature (20-25° C.), and treated as necessary.

The polar solvent can be a single organic compound or a mixture of compounds. The solvent is one in which the monomers are miscible or dispersible. The solvent can be present in an amount of 10-70 wt. %, or 20-50 wt. % based on the total weight of the reaction mixture. In one embodiment, the polar solvent can be an aprotic organic solvent, such as (cyclo)alkanone, cyclic ester, a linear or branched ketone, or C₁₋₈ esters.

The radical initiator is generally an azo compound or an organic peroxide. In one embodiment, the radical initiator is an oil soluble azo compound. Such initiators can include, for example, dimethyl 2,2′-azobis(2-methylpropionate) and 2,2′-azobis(2,4-dimethylvaleronitrile). The total initiator added can be in a range of 1-5 wt. %, based on the weight of the starting reaction mixture.

The present disclosure is also directed to a polymeric dielectric film. The polymeric films can be prepared from liquid compositions comprising the chemical compositions of the present disclosure and one or more organic solvents, in which the above-described polymers in the chemical composition dissolved or dispersed in the solvents. The liquid compositions can be deposited or coated onto a substrate using any known technique and heated to remove solvents. This can be followed by an additional heating step to cure the film.

In some embodiments, the liquid compositions of the present disclosure can be used to form a dielectric film for photolithography, packaging, adhesive, sealing and bulk dielectric applications, such as in spin on coatings or buffer layers. The dielectric film formed on the substrate can be used directly or can be peeled off and used on different substrates in electronic devices.

Suitable organic solvents are those in which the polymers are soluble. Exemplary organic solvents include, without limitation: polar protic and polar aprotic solvents, for example: alcohols such as 2-methyl-1-butanol, 4-methyl-2-pentanol, and methyl isobutyl carbinol; esters such as ethyl lactate, propylene glycol methyl ether acetate, methyl 2-hydroxyisobutyrate, methyl 3-methoxypropionate, n-butyl acetate and 3-methoxy-1-butyl acetate; lactones such as gamma-butyrolactone; lactams such as N-methylpyrrolidinone; ethers such as propylene glycol monomethyl ether and dipropylene glycol dimethyl ether isomers, such as PROGLYDE™ DMM (The Dow Chemical Company, Midland, Mich.); ketones such as 2-butanone, cyclopentanone, cyclohexanone and methylcyclohexanone; and mixtures thereof.

Other organic solvents can also be used, including propylene glycol monomethyl ether acetate, 3-methoxypropionate, anisole, mesitylene, 2-heptanone, cyrene, 2-butanone, ethyl lactate, amyl acetate, n-butyl acetate, n-methyl-2-pyrrolidone, N-butyl-2-pyrrolidone.

Suitable additives can be added into the liquid compositions of the present disclosure. Examples of the additives can include, without limitation, one or more curing agents, surfactants, inorganic fillers, organic fillers, plasticizers, adhesion promoters, metal passivating materials, anti-foam agents, and combinations of any of the foregoing. Suitable surfactants are well-known to those skilled in the art. In one embodiment, the surfactants can be nonionic surfactants. Such surfactants may be present in an amount of from 0 to 10 g/L, or from 0 to 5 g/L.

Any suitable inorganic fillers may optionally be used in the present liquid compositions, and are well-known to those skilled in the art. Exemplary inorganic fillers can include, but are not limited to, silica, silicon carbide, silicon nitride, alumina, aluminum carbide, aluminum nitride, zirconia, and the like, and mixtures thereof. The inorganic fillers may be in the form of a powder, rods, spheres, or any other suitable shape. Such inorganic fillers may have any suitable dimensions. Such inorganic fillers may comprise a coupling agent, such as a silane or a titanate in conventional amounts. Inorganic fillers may be used in an amount of from 0 to 80 wt. %, or from 40 to 80 wt. %, as solids based on the total weight of the composition. In some embodiments, no inorganic fillers are present.

In one embodiment, the metal passivating material is a copper passivating agent. Suitable copper passivating agents are well known in the art and include imidazoles, benzotriazoles, ethylene diamine or its salts or acid esters, and iminodiacetic acids or salts thereof.

A variety of curing agents may also be used in the liquid compositions of the present disclosure. Exemplary curing agents include, but are not limited to, thermally generated initiators and photoactive compounds (photogenerated initiators). The selection of such curing agents is within the ability of those skilled in the art. Preferred thermal generated initiators are free radical initiators, such as, but not limited to, azobisisobutyronitrile, dibenzoyl peroxide, and dicumylperoxide. Preferred photoactive curing agents are free radical photoinitiators available from BASF under the Irgacure brand, and diazonaphthoquinone (DNQ) compounds including sulfonate esters of a DNQ compound. Suitable DNQ compounds are any compounds having a DNQ moiety, such as a DNQ sulfonate ester moiety, and that function as photoactive compounds in the liquid compositions of the present disclosure, that is, they function as dissolution inhibitors upon exposure to appropriate radiation. The amount of photoactive compound varies from 0 to 30 wt. %, based on the total weight of the polymer solids. When present, the photoactive compound is typically used in an amount of 5 to 30 wt. %, or from 5 to 25 wt. %, or from 10 to 25 wt. %, based on the total weight of chemical composition solids.

Any suitable adhesion promoter may be used in the liquid compositions of the present disclosure and the selection of such adhesion promoter is well-known within the ability of those skilled in the art. Preferred adhesion promoters are silane-containing materials or tetraalkyl titanates, or trialkoxysilane-containing materials. Exemplary adhesion promoters can include, but are not limited to, bis(trialkoxysilylalkyl)benzenes such as bis(trimethoxysilylethyl)benzene; aminoalkyl trialkoxy silanes such as aminopropyl trimethoxy silane, aminopropyl triethoxy silane, and phenyl aminopropyl triethoxy silane; and other silane coupling agents, as well as mixtures of the foregoing. Particularly suitable adhesion promoters include AP 3000, AP 8000, and AP 9000C (Dow Electronic Materials, Marlborough, Mass.). The liquid compositions of the present disclosure may contain from 0 to 15 wt. % of an adhesion promoter, or from 0.5 to 10 wt. %, or from 1 to 10 wt. %, or from 2 to 10 wt. %. based on the total weight of the composition.

Any anti-foam agent or defoamer known in the art can be used in the present application. Exemplary anti-foam agents include silicone oil such as polysiloxane, polyvinyl alcohol, mineral oil, octanol, ethylene bis amide such as ethylene bis stearamide, or a mixture thereof.

In one aspect, the liquid compositions can be coated or deposited onto a substrate using any known technique and heated to remove solvent to form a film and the film can then be cured by an additional heating step. Suitable methods for coating or disposing the liquid compositions of the present disclosure can include, but are not limited to, spin-coating, curtain coating, spray coating, roller coating, dip coating, vapor deposition, and lamination such as vacuum lamination, among other methods.

In the semiconductor manufacturing industry, spin-coating is a preferred method to take advantage of existing equipment and processes. In spin-coating, the solids content of the liquid composition may be adjusted, along with the spin speed, to achieve a desired thickness of the composition on the surface it is applied to. Various vapor treatments known in the art may be used to increase the adhesion of the polymers of the present disclosure to the substrate surface, such as plasma treatments. In certain applications, it may be preferred to use an adhesion promoter to treat the substrate surface prior to coating the surface with the liquid compositions of the present disclosure.

Typically, the liquid compositions of the present disclosure are spin-coated at a spin speed of 400 to 4000 rpm. The amount of the liquid compositions dispensed on a wafer or substrate depends on the total solids content in the composition, the desired thickness of the resulting layer, and other factors well-known to those skilled in the art. When a film or layer of the liquid compositions is cast by spin-coating, much (or all) of the solvent evaporates during deposition of the film. Preferably, after being disposed on a surface, the composition is heated (soft-baked) to remove any remaining solvent. Typical baking temperatures can be changed from 70 to 150° C., or from 90 to 120° C., although other temperatures may be suitably used. Such baking to remove residual solvent is typically done for approximately one or two minutes, although longer or shorter times may suitably be used. Then, the coated composition are cured by heating for a period of time. Suitable curing temperatures range from 100 to 300° C., or from 100 to 250° C., or from 120 to 250° C., or from 140 to 200° C. Typically curing times range from 1 to 600 minutes, or from 30 to 240 minutes, or from 30 to 120 minutes.

In another aspect, layers of the liquid compositions of the present disclosure may also be formed as a free-standing dry film and then disposed on the surface of a substrate by lamination. A variety of suitable lamination techniques, including vacuum lamination techniques, may be used and are well known to those skilled in the art. In forming a dry free-standing film, the liquid compositions of the present disclosure are first disposed, such as coated, onto a front surface of a suitable film support sheet. The support sheet can be a polyester sheet such as polyethylene terephthalate (PET) sheet, or a polyimide sheet such as KAPTON™ polyimide (DuPont, Wilmington, Del.), using slot-die coating, gravure printing, or another appropriate method. The coated composition is then soft baked at a suitable temperature, such as from 90 to 140° C., for an appropriate time, such as from 1 to 30 minutes, to remove any solvent.

A polymer film cover sheet such as polyethylene is then roll-laminated at room temperature (20-25° C.) onto the dried composition to protect the composition during storage and handling. To dispose the dried composition onto the substrate, the cover sheet is first removed. Then, the dried composition on the support sheet is laminated onto the substrate surface using roll-lamination or vacuum lamination. The lamination temperature can range from 20 to 120° C. The support sheet is then removed (peeled), leaving the dried composition on that surface.

When the liquid compositions of the present disclosure which do not contain an adhesion promoter are used, the surface of the substrate to be coated with the liquid compositions may optionally first be contacted with a suitable adhesion promoter using liquid or vapor treatment. Such treatments improve the adhesion of the liquid compositions of the present disclosure to the substrate surface.

Any substrate known in the art can be used in the present disclosure. Examples of the substrate can include, but are not limited to, silicon, copper, silver, indium tin oxide, silicon dioxide, glass, silico nitride, aluminum, gold, polyimide and epoxy mold compound.

The dielectric film of the present disclosure can have Dk values less than 3.0, or less than 2.7, or less than 2.6, or less than 2.5, or less than 2.4 and Df values less than 0.006, or less than 0.004, or less than 0.0035, or less than 0.003 at high frequencies. The high frequency can be 20 GHz, or 30 GHz, or 40 GHz, or 50 GHz, or 60 GHz, or 70 GHz, or 80 GHz, or 90 GHz, or 100 GHz. In addition, the resulting cured dielectric film has good tensile strength, tensile elongation, good adhesion to desired substrates such as copper. The elongation of the dielectric film can be greater than 10%, or 15%, or 20%, or 30%, or 40%, or 50%, or 60%, or 70%, or 80%, or 90%. The tensile strength of the film can be greater than 50 MPa, or 55 MPa, or 60 MPa, or 70 MPa, or 80 MPa, or 90 MPa, or 95 MPa.

The present disclosure is also directed to a wide variety of electronic devices comprising at least one layer of the dielectric film of the present disclosure on an electronic device substrate. The electronic device substrate can be any substrate for use in the manufacture of any electronic device. Exemplary electronic device substrates include, without limitation, semiconductor wafers, glass, sapphire, silicate materials, silicon nitride materials, silicon carbide materials, display device substrates, epoxy mold compound wafers, circuit board substrates, and thermally stable polymers. As used herein, the term “semiconductor wafer” is intended to encompass a semiconductor substrate, a semiconductor device, and various packages for various levels of interconnection, including a single-chip wafer, multiple-chip wafer, packages for various levels, substrates for light emitting diodes (LEDs), or other assemblies requiring solder connections. Semiconductor wafers, such as silicon wafers, gallium-arsenide wafers, and silicon-germanium wafers, may be patterned or unpatterned. As used herein, the term “semiconductor substrate” includes any substrate having one or more semiconductor layers or structures which include active or operable portions of semiconductor devices. The term “semiconductor substrate” is defined to mean any construction comprising semiconductive material, such as a semiconductor device. A semiconductor device refers to a semiconductor substrate upon which at least one microelectronic device has been or is being fabricated. Thermally stable polymers include, without limitation, any polymer stable to the temperatures used to cure the arylcyclobutene material, such as polyimide, for example, KAPTON™ polyimide (DuPont, Wilmington, Del.), liquid crystalline polymers, for example VECSTAR™ LCP film (Kuraray, Tokyo, Japan) and Bismaleimide-Triazine (BT) resins (MGC, Tokyo, Japan).

### EXAMPLES

The concepts described herein will be further illustrated in the following examples, which do not limit the scope of the present disclosure described in the claims.

### Materials

Beta-myrcene was purchased from Vigon International. Inc., styrene was purchased from Sigma Aldrich, vinyl toluene isomeric mixture was received from Deltech Corporation, and Vazo 65 initiator was purchased from Fujifilm Wako Chemicals U.S.A. Corporation. 4-vinyl pyridine was obtained from Vertellus and used as received. BMI-689 was received from Designer Molecules Inc. 1,6′-bismaleimide-(2,2,4-trimethyl)hexane (TMH-BMI) was received from Daiwa Kasei. 1,3-bis(3-maleimidephenoxy)benzene (APB-BMI) was received from Hampford Research, Inc. 2,2′-Bis(trifluoromethyl)benzidine, benzenamine, 4,4′-[1,3-phenylenebis(oxy)]bis-, benzenamine, 4,4′-[[2,2,2-trifluoro-1-(trifluoromethyl) ethylidene]bis(4,1-phenyleneoxy)]bis-, acetic anhydride and maleic anhydride were purchased from TCI America. 1-(4-Vinylphenoxy benzocyclobutene (BCB) was prepared according to US Pat Application No 20190169327A1, the entire contents of which are incorporated herein by reference. All other solvents and chemicals were received from the Dow Chemical Company and used as received without additional purification.

### Molecular Weight Determination Procedure

Polymer sample was prepared as a 0.5 wt. % solution in tetrahydrofuran (THF) and filtered through a 0.2 microns Teflon filter. The mobile phase was 0.5% triethylamine, 5% methanol and 94.5% tetrahydrofuran. The columns were Waters Styragel HR5E 7.8×300 mm column lot number 0051370931. Injection volume was 100 microliters and run time was 27 minutes. Molecular weight data was reported relative to polystyrene standards.

### Synthesis

### Example 1—Polymer 1

The following monomers and solvent were added to a 5 L jacketed reactor with overhead stirring and heat to 80° C. under a nitrogen blanket: 1044.59 g 1-(4-vinylphenoxy)benzocyclobutene, 778.34 g vinyl toluene, 80.18 g vinyl pyridine, 447.67 g beta-myrcene and 997.04 g cyclohexanone. An initiator of 71.67 g V65 in 888.21 g cyclohexanone was fed at a constant rate into the reactor for 20 hours, and temperature was held at 80° C. for an additional 2 hours before reduced to 25° C. The solution was used directly in the following formulation Examples. GPC Mn 9.03 k, Mw 51.18 k.

### Example 2—MA TFMB

30 g of 2,2′-Bis(trifluoromethyl)benzidine was added to a 250 ml round bottom flask and was dissolved in 105 ml of tetrahydrofuran (THF). When dissolution was complete via magnetic stirring, 7.96 g of maleic anhydride was added. The solution was stirred for 2 hours at 23° C., and the resulting precipitated white solid was filtered and washed with THF. The solid was added into a new 250 ml round bottom flask with magnetic stirring, and 42 ml of acetic anhydride and 1.33 g of sodium acetate were added. The mixture was heated to 80° C. for 2 hours, then 98 ml of water was poured to obtain a tan solid (18.2 g). The obtained MA-TFMB has the following general formula.

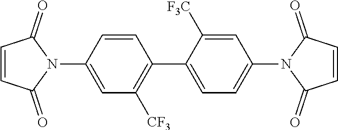

### Example 3-1,3 Bis-4 PhoBMI

A similar procedure as Example 2 was used, except using 10 g of benzenamine, 4,4′-[1,3-phenylenebis(oxy)]bis-; 6.71 g of maleic anhydride; 33 ml of tetrahydrofuran; 70 ml of acetic anhydride; 3.4 g of sodium acetate and precipitated into 99 ml of water. 12.7 g of a colorless solid was obtained. The obtained 1,3 Bis-4 PhoBMI has the following general formula.

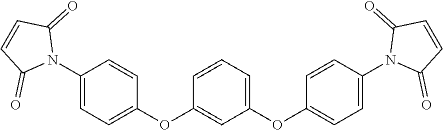

### Example 4—BMP3 CF3

A similar procedure as Example 2 was used, except using 10 g of benzenamine, 4,4′-[[2,2,2-trifluoro-1-(trifluoromethyl)ethylidene]bis(4,1-phenyleneoxy)]bis-; 3.78 g of maleic anhydride; 28 ml of tetrahydrofuran; 39 ml of acetic anhydride; 1.9 g of sodium acetate and precipitated into 99 ml of water. 11.1 g of a colorless solid was obtained. The obtained BMP3 CF3 has the following general formula.

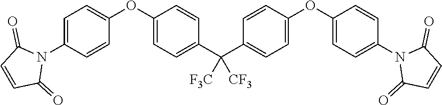

### Polymer Formulation

### Example 5

To a 20 ml glass vial, 11.127 g of Polymer 1 solution (55 wt. % of Polymer 1 prepared in Example 1 was dissolved in cyclohexanone) and 1.53 g of MA TFMA prepared in Example 2 were added. Then, 2.343 g of cyclopentanone was added into the vial. The vial was sealed and rolled overnight to homogenize, then filtered through a 5 microns Nylon™ filter. The solution was allowed to degas for 3 hours at ambient conditions before coating.

### Example 6

Polymer formulation was prepared in the same manner as Example 5, except that 9.597 g of Polymer 1 solution prepared from Example 5, 2.372 g of APB-BMI and 3.031 g of cyclopentanone were used.

### Example 7

Polymer formulation was prepared in the same manner as Example 5, except that BMP3 CF3 prepared in Example 4 was used such that the final formulation was 51% solids and contained 20 wt. % of BMP3 CF3.

### Example 8

Polymer formulation was prepared in the same manner as Example 5, except that 1,3 Bis 4-PhoBMI prepared in Example 5 was used such that the final formulation was 51% solids and contained 31 wt. % of BMI 1,3 Bis 4-PhoBMI.

### Example 9

Polymer formulation was prepared in the same manner as Example 5, except that BMI-689 was used such that the final formulation was 51% solids and contained 40 wt. % of BMI-689.

### Example 10

Polymer formulation was prepared in the same manner as Example 5, except that TMH-BMI was used such that the final formulation was 51% solids and contained 8 wt. % of TMH-BMI.

### Film Preparation

Films were prepared by spin coating the polymer formulations prepared as above onto copper-coated wafer substrates with 200 mm in diameter. After spin coating, the coated wafers were soft baked at 120° C. for 180 seconds. The resulting film was then baked at 200° C. for one (1) hour under a nitrogen atmosphere to further cure the film. The wafer was then diced into the desired pieces and the film was delaminated from the wafer using a 5% aqueous ammonium sulfate solution. The resulting film sections were analyzed to measure material properties, such as dielectric and mechanical properties.

Analysis of Dielectric properties

The dielectric properties of free-standing films were determined by using a split cylinder resonator operating at 20 GHz and a Keysight N5224A PNA network analyzer. Free-standing film of the appropriate size for the split cylinder resonator was placed in the resonator such that the film was larger than the diameter of the cavity. The frequency and the Q factor of the cavity were recorded both with and without the film of interest. Using the frequency and Q factors, the dielectric properties, dielectric constant (Dk) and loss tangent (Df), were calculated using software written in MATLAB.

### Analysis of Mechanical Properties

Films samples that were cut into 1 cm×6 cm and analyzed via a pull test method using an Instron pull tester 33R4464. The film samples were securely clamped and pulled at the desired rate. The force vs. strain was recorded and the elongation and tensile strength of each sample were determined using the appropriate analysis software. Table 1 lists the test results.

TABLE 1

| | Wt. % of | Dk | Df | Elongation | Tensile strength |
|---|---|---|---|---|---|
| Example | BMI | 20 GHz | 20 GHz | % | MPa |
| 5 | 20 | 2.24 | 0.0035 | 21 | 84 |
| 6 | 10 | 2.37 | 0.0027 | 14 | 96 |
| 7 | 20 | 2.45 | 0.0041 | 22 | 84 |
| 8 | 31 | 2.69 | 0.0054 | 22 | 88 |
| 9 | 40 | 2.48 | 0.0017 | 85 | 55 |
| 10 | 8 | 2.35 | 0.0032 | 8 | 69 |

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any sub combination.

What is claimed is:

1. A chemical composition comprising a polymer produced from polymerizing a monomer comprising an arylcyclobutene monomer, and a bismaleimide compound.

2. The chemical composition of claim 1, wherein the bismaleimide compound is represented by a general Formula (I): 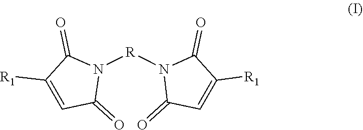
where R is substituted or unsubstituted linking group selected from the group consisting of alkylene, alkylenearyl, cycloalkylene, cycloalkylenearyl, cycloalkylalkylene, dialkyl siloxane, diarylsiloxane, aryl, heteroaryl, aryloxy, arylamino, arylthio, and combinations thereof; and R₁ is selected from the group consisting of hydrogen, deuterium, halogen, cyano, methyl, vinyl, allyl, isoprene, a substituted or unsubstituted isoprene having 1-100 carbon atoms, and combinations thereof.

3. The chemical composition of claim 2, wherein R is substituted or unsubstituted linking group selected from the group consisting of alkylene having 10 to 100 carbon atoms, alkylenearyl, cycloalkylene, cycloalkylenearyl, cycloalkylalkylene, and combinations thereof.

4. The chemical composition of claim 1, wherein the bismaleimide compound is selected from the group consisting of C36 alkylenediamine imides, 1,6′-bismaleimide-(2,2,4-trimethyl)hexane 1,3-bis(3-maleimidephenoxy)benzene (APB-BMI), 1,1′-[2,2′-Bis(trifluoromethyl)[1,1′-biphenyl]-4,4′-diyl]bis[1H-pyrrole-2,5-dione] (MA-TFMB), 2,2-Bis[4-(4-maleimidophenoxy)phenyl]hexafluoropropane (BMP3 CF3), and 1,3-Bis(4-maleimidophenoxy)benzene (1,3 Bis 4-PhoBMI).

5. The chemical composition of claim 1, wherein the arylcyclobutene monomer is represented by a general Formula (II) or (III), 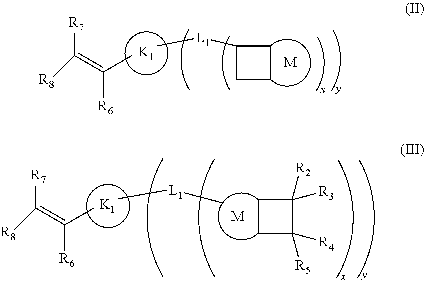
where:
K₁ is a divalent group selected from the group consisting of alkyl, aryl, carbocyclic aryl, polycyclic aryl, heteroaryl, aryloxy, arylalkyl, carbonyl, ester, carboxyl, ether, thioester, thioether, tertiary amine, and combinations thereof;
L₁ is a covalent bond or a multivalent linking group;
M is a substituted or unsubstituted divalent aromatic or polyaromatic radical group, or a substituted or unsubstituted divalent heteroaromatic radical group;
R₂-R₅ are identical or different and each is independently selected from the group consisting of unsubstituted or substituted alkyl, unsubstituted or substituted alkyloxy, unsubstituted or substituted aryl, unsubstituted or substituted aryloxy, alkylthio, arylthiol, substituted alkyl amino, substituted aryl amino, and combinations thereof;
R₆-R₈ are identical or different and each is independently selected from the group consisting of hydrogen, deuterium, cyano, halo, methyl, vinyl, allyl, isoprene, a substituted or unsubstituted isoprene having 1-100 carbon atoms; and
x and y are the same or different and are an integer from 1 to 5, wherein when L₁ is a covalent bond, y=1.

6. The chemical composition of claim 1, wherein the monomer further comprises a monomer having one or more dienophile moieties.

7. The chemical composition of claim 6, wherein the monomer having one or more dienophile moieties is represented by a general Formula (IV), 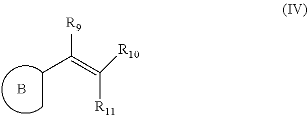
where B is hydrogen, substituted or unsubstituted alkyl, substituted or unsubstituted aromatic moiety, substituted or unsubstituted heteroaromatic moiety, hydroxy, or substituted or unsubstituted alkyloxy; and R₉-R₁₁ are identical or different and each independently are selected from the group consisting of hydrogen, methyl, vinyl, allyl, isoprene, a substituted or unsubstituted isoprene having 1-100 carbon atoms, a substituted or unsubstituted alkyl group having 1 to 100 carbon atoms, a halogen, a cyano, a substituted or unsubstituted aryl group having 6 to 100 carbon atoms, a substituted or unsubstituted heteroaryl group having 6 to 100 carbon atoms, and combinations thereof.

8. The chemical composition of claim 6, wherein the monomer further comprises at least one diene monomers.

9. The chemical composition of claim 8, wherein the diene monomer is presented by a general Formula (V), 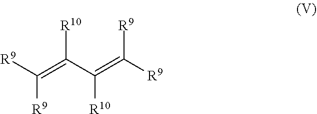
where R⁹ is the same or different at each occurrence and is selected from hydrogen and methyl; and R¹⁰ is the same or different at each occurrence and is selected from hydrogen, C₁₋₅ alkyl, C₁₋₅ alkoxy, C₁₋₅ thioalkyl, and C₅₋₁₂ alkenyl.

10. The chemical composition of claim 8, wherein the monomer further comprises at least one nitrogen heterocycle containing monomer.

11. A liquid composition comprising the chemical composition of claim 1 in at least one organic solvent.

12. The liquid composition of claim 11, wherein the organic solvent is selected from the group consisting of cyclopentanone, cyclohexanone, propylene glycol monomethyl ether, propylene glycol monomethyl ether acetate, gamma-butyrolactone, 3-methoxypropionate, dipropylene glycol dimethyl ether, 3-methoxybutyl acetate, anisole, mesitylene, 2-heptanone, cyrene, 2-butanone, ethyl lactate, amyl acetate, n-butyl acetate, n-methyl-2-pyrrolidone, and N-butyl-2-pyrrolidone.

13. A liquid composition comprising the chemical composition of claim 6 in at least one solvent.

14. A liquid composition comprising the chemical composition of claim 8 in at least one solvent.

15. A liquid composition comprising the chemical composition of claim 10 in at least one solvent.

16. A dielectric film prepared by depositing the liquid composition of claim 11 onto a substrate and heating.

17. The dielectric film of claim 16, wherein the substrate is selected from the group consisting of copper, silver, indium tin oxide, glass, silicon, silicon dioxide, silicon nitride, aluminum, gold, polyimide and epoxy mold compound.

18. The dielectric film of claim 17, wherein the film has an elongation greater than 10% and a tensile strength greater than 55 MPa.

19. The dielectric film of claim 17, wherein the film has a Dk≤2.6 and a Df≤0.004 at 20 GHz.

20. An electronic device having at least one layer comprising the dielectric film of claim 16.
